(19) United States
(12) Patent Application Publication
(10) Pub. No.: US 2003/0048070 A1
(43) Pub. Date: Mar. 13, 2003

(54) Method and apparatus for forming barrier ribs for use in flat panel displays, and back plates for flat panel displays manufactured by this method

(75) Inventor: Manabu Yabe, Kyoto (JP)

Correspondence Address: McDermott, Will & Emery, 600 13th Street, N.W., Washington, DC, 20005-3096, US

(73) Assignee: Dainippon Screen Mfg. Co., Ltd.

(21) Appl. No.: 10/230,985

(22) Filed: Aug. 30, 2002

(30) Foreign Application Priority Data
Sep. 13, 2001 (JP) JP2001-277623

(51) Int. Cl. H01J 1/96; H01J 17/49; H01J 1/90

(52) U.S. Cl. 313/495

(57) ABSTRACT

A rib material is delivered to a back plate from a direction tilted forward with respect to a direction of movement of a nozzle relative to the back plate. This delivery mode applies a horizontal velocity component to the rib material in a direction corresponding to the direction of movement of the nozzle relative to the back plate. A velocity difference between the horizontal velocity component of the rib material and a relative moving velocity component of the back plate resulting from the relative movement between the nozzle and back plate is reduced for equalization. This suppresses deformation of the rib material delivered, thereby depositing the rib material on the back plate in a desired shape determined by discharge openings of the nozzle. Barrier ribs are thereby formed with high accuracy.

### BACKGROUND OF THE INVENTION

(1) Field of the Invention

This invention relates to flat panel displays such as plasma display panels built into computer display terminals, wall-mounted television receivers or the like. More particularly, the invention relates to a technique for forming barrier ribs.

(2) Description of the Related Art

Conventional barrier rib forming methods of the type noted above include, for example, “sand blast methods”, “screen printing”, “lift-off methods” and “mold process”. A “sand blast method” includes the steps of applying a rib material over an entire surface of a back plate, coating a sensitive film thereon, exposing and developing the film, carrying out a blast process, with a resist left in locations for forming barrier ribs, to remove unwanted parts of the rib material, removing the resist, and carrying out a baking process. A “lift-off method” includes the steps of applying a sensitive resist over an entire surface of a back plate, exposing and developing the sensitive resist to remove the resist only from locations for forming barrier ribs, filling recesses with a rib material, and removing the sensitive resist. The “mold process” includes the steps of applying a rib material over an entire surface of a back plate, and pressing a mold defining recesses against locations for forming barrier ribs.

The conventional methods with the above steps have the following drawbacks.

The “sand blast methods” and “lift-off methods”, which are the typical examples, have drawbacks of requiring a large number of steps, taking a long processing time, and involving a low material use efficiency. The “screen printing” has a drawback of low quality and low processing accuracy.

The “mold process” could damage the barrier ribs when removing the mold, and hence a drawback of low quality and low processing accuracy.

A method has been proposed to deliver a rib material from a nozzle to form barrier ribs (e.g. Japanese Patent Publication (Unexamined) No. 1997-92134). However, this method is unrealistic in that it is impossible to form barrier ribs with a high aspect ratio (i.e. a ratio of height to width).

Where, as shown in FIG. 1, barrier ribs W are formed on a back plate S by delivering a rib material M_{w} from a nozzle 100 with circular discharge openings while the nozzle 100 is moved in vertical posture and horizontally relative to the back plate S, the rib material M_{w} undergoes a considerable deformation immediately after delivery from the nozzle 100, resulting in irregular shapes of the barrier ribs W formed on the back plate S. This renders rib forming controls extremely difficult to form barrier ribs W with high accuracy, or to form barrier ribs W in a desired steady shape.

To increase brightness of a flat panel display, as shown in FIG. 2, barrier ribs W shown in two-dot chain lines may be uniformly reduced in width from top to bottom to provide an enlarged emission space H between the barrier ribs W shown in solid lines. Then, the top of each barrier rib W becomes narrow compared with the width of emission space H, which causes image quality lacking in “life” or “force”. The reduced width at the bottom of each barrier rib W poses a problem of weak adhesion to the back plate S. Where, as shown in FIG. 3, barrier ribs W have a reduced width except at tops thereof to provide an enlarged emission space H, the “life” of image quality is secured since the top of each barrier rib W is maintained wide relative to the width of emission space H. However, the reduced width at the bottom of each barrier rib W has weak adhesion to the back plate S. Where as shown in FIG. 4, barrier ribs W have a reduced width except at bottoms thereof to provide an enlarged emission space H, the barrier ribs W have good adhesion to the back plate S. However, the “life” of image quality is lost since the width at the tops of barrier ribs W is reduced relative to the width of emission space H.

From the above, barrier ribs W having a vertical section like an hourglass may be formed on the back plate S as shown in FIG. 13, which is considered to secure excellent adhesion to the back plate S of the barrier ribs W and to provide a flat panel display highly bright and having image quality with “life”. However, none of the methods noted hereinbefore can form barrier ribs W of such special shape on the back plate S.

### SUMMARY OF THE INVENTION

This invention has been made having regard to the state of the art noted above, and its primary object is to provide a method and apparatus for forming barrier ribs for use in flat panel displays, the barrier ribs being formed with high material use efficiency and a high degree of accuracy, and yet with a high aspect ratio.

A secondary object of this invention is to provide a flat panel display having barrier ribs formed on a back plate by the above barrier rib forming method and apparatus, in which excellent adhesion to the back plate of the barrier ribs is secured, and which is highly bright and has image quality with “life”.

To fulfill the above objects, Inventor has made intensive research and attained the following findings. The problem of the rib material being considerably deformed immediately after delivery from a nozzle is found to arise from the following fact. The rib material is extruded from the nozzle vertically to the back plate. That is, the rib material is delivered to the back plate with only a force of vertical velocity component applied to the rib material. However, the rib material, immediately after delivery from the nozzle, is suddenly subjected to a force of horizontal relative moving velocity component of the back plate resulting from relative movement between the nozzle and back plate, e.g. horizontal movement of the back plate relative to the nozzle. To what extent a composition of these forces affects the height or width of barrier ribs formed on the back plate is unknown. This is believed the cause of instability in the shape of barrier ribs formed on the back plate, making it impossible to form barrier ribs with high accuracy. Based on this recognition, the rib material is delivered from a direction tilted, relative to the back plate, forward with respect to a direction of relative movement of the nozzle. This applies a horizontal velocity component acting in a direction of relative movement of the back plate, to the rib material delivered to the back plate. The horizontal velocity component of the rib material is made equal to a relative moving velocity component of the back plate resulting from the relative movement between the nozzle and back plate. That is, a velocity difference is reduced. This delivery mode suppresses deformation of the rib material delivered, thereby depositing the rib material on the back plate in a desired shape determined by the discharge openings of the nozzle.

Based on the above findings, this invention provides a method of forming barrier ribs on a back plate for use in a flat panel display, the method comprising:

a relative moving step for moving a rib material delivery nozzle and the back plate relative to each other, with at least flow channels of a rib material in an exit portion of the nozzle tilted relative to the back plate, the flow channels being tilted such that upper portions thereof are tilted forward, with respect to a moving direction of the nozzle relative to the back plate, about lower ends of the flow channels; and

a rib material delivery step for delivering the rib material from the nozzle while moving the nozzle and the back plate relative to each other.

In the above method, the relative moving step is executed with at least flow channels of the rib material in an exit portion of the nozzle tilted relative to the back plate. Moreover, the flow channels are tilted such that upper portions thereof are tilted forward, with respect to the moving direction of the nozzle relative to the back plate, about the lower ends of the flow channels. In this forwardly tilted state, the nozzle and back plate are moved relative to each other, the nozzle moving in the above moving direction relative to the back plate. The rib material delivery step is executed to deliver the rib material from the nozzle while moving the nozzle and the back plate relative to each other.

Thus, the rib material is delivered from a direction tilted, relative to the back plate, forward with respect to the direction of relative movement of the nozzle to apply a horizontal velocity component acting in the direction of relative movement of the back plate, to the rib material delivered to the back plate. The horizontal velocity component of the rib material is made equal to a relative moving velocity component of the back plate resulting from the relative movement between the nozzle and back plate. That is, a velocity difference is reduced. This delivery mode suppresses deformation of the rib material delivered, thereby depositing the rib material on the back plate in a desired shape determined by the discharge openings of the nozzle. This stabilizes the shape of the barrier ribs, and facilitates barrier rib forming controls to obtain the desired shape. The material may be used efficiently to form barrier ribs with high accuracy.

Preferably, the above method further comprises a rib material curing step for curing the rib material on the back plate while delivering the rib material from the nozzle. This step is effective to maintain the shape of the rib material delivered to the back plate. As a result, the process is simplified to form barrier ribs with high quality and high accuracy. Moreover, with the improved efficiency of using the material, a cost reduction may be achieved. With the rib material cured while being delivered, barrier ribs of high aspect ratio may be formed.

In another aspect of the invention, an apparatus is provided for forming barrier ribs on a back plate for use in a flat panel display, the apparatus comprising:

a nozzle for delivering a rib material;

a support table for supporting the back plate; and

a moving device for moving the nozzle and the support table relative to each other;

wherein the rib material is delivered from the nozzle while the nozzle and the back plate relative to each other, with at least flow channels of the rib material in an exit portion of the nozzle tilted relative to the back plate, the flow channels being tilted such that upper portions thereof are tilted forward, with respect to a moving direction of the nozzle relative to the back plate, about lower ends of the flow channels.

With this apparatus, at least flow channels of the rib material in an exit portion of the nozzle are tilted relative to the back plate. Moreover, the flow channels are tilted such that upper portions thereof are tilted forward, with respect to the moving direction of the nozzle relative to the back plate, about the lower ends of the flow channels. In this forwardly tilted state, the moving device is operated to move the nozzle and back plate relative to each other, the nozzle moving in the above moving direction relative to the back plate. The rib material is delivered from the nozzle while the nozzle and the back plate are moved relative to each other. Thus, the rib material is delivered from a direction tilted, relative to the back plate, forward with respect to the direction of relative movement of the nozzle to apply a horizontal velocity component acting in the direction of relative movement of the back plate, to the rib material delivered to the back plate. The horizontal velocity component of the rib material is made equal to a relative moving velocity component of the back plate resulting from the relative movement between the nozzle and back plate. That is, a velocity difference is reduced. This delivery mode suppresses deformation of the rib material delivered, thereby depositing the rib material on the back plate in a desired shape determined by the discharge openings of the nozzle.

Preferably, the above apparatus further comprises a curing device for curing the rib material delivered to the back plate, the curing device curing the rib material on the back plate while the rib material is delivered from the nozzle. The rib material delivered to the back plate is thereby maintained in shape. As a result, the process is simplified to form barrier ribs with high quality and high accuracy. Moreover, with the improved efficiency of using the material, a cost reduction may be achieved. With the rib material cured while being delivered, barrier ribs of high aspect ratio may be formed.

Preferably, the nozzle has discharge openings vertically elongated in front view. This construction can form barrier ribs having an elongated vertical section.

Preferably, the nozzle is disposed such that the discharge openings have long sides thereof tilted relative to the back plate to be directed reverse to the moving direction. The rib material delivered from lower portions of the discharge openings contacts the back plate relatively hard, to attain strong adhesion of the rib material to the back plate. The rib material is delivered with less force from upper portions of the discharge openings, to realize a high aspect ratio without deforming the barrier ribs. Thus, barrier ribs of high aspect ratio may be formed on the back plate.

Preferably, each of the discharge openings is hourglass-shaped with an upper end and a lower end thereof enlarged in front view. This construction can form barrier ribs having a hourglass-shaped section with enlarged upper and lower ends.

Preferably, each of the discharge openings has curved edges defining bulges. This construction can form barrier ribs having a hourglass-shaped section and curved edges defining bulges.

Preferably, the nozzle has opening planes defining the discharge openings and protruding in a direction of delivery of the rib material. This construction facilitates delivery of the rib material as retaining the shape determined by inner walls of the nozzle, thereby further stabilizing the shape of the rib material delivered to the back plate.

Preferably, each of the discharge openings includes a parallel opening plane formed forwardly with respect to the moving direction of the nozzle relative to the back plate and substantially parallel to the back plate, and an inclined opening plane continuous with the parallel opening plane and formed rearwardly with respect to the moving direction and inclined relative to the back plate, the parallel opening plane and the inclined opening plane forming an angle beta therebetween which is at least 90 degrees and less than 180 degrees. With this construction, the discharge openings of the nozzle may be placed close to the back plate while securing formation of the barrier ribs having a high aspect ratio. The rib material may easily be delivered as retaining the shape determined by inner walls of the nozzle, thereby further stabilizing the shape of the rib material delivered to the back plate.

In a further aspect of the invention, there is provided a flat panel display comprising barrier ribs formed on a back plate, wherein the barrier ribs are formed on the back plate, each to have a hourglass-like shape with an upper end and a lower end thereof enlarged.

The flat panel display according to this invention has barrier ribs formed on the back plate, each rib having a hourglass-like shape with an upper end and a lower end thereof enlarged. Consequently, the barrier ribs have strong adhesion to the back plate, while the display is highly bright and provides image quality with “life”.

Preferably, each of the barrier ribs has curved sides defining bulges. These barrier ribs have increased surface areas on the sides thereof to realize a flat panel display with increased brightness.

In a still further aspect of the invention, a back plate for a flat panel display comprises barrier ribs formed thereon by moving a rib material delivery nozzle and the back plate relative to each other, with at least flow channels of a rib material in an exit portion of the nozzle tilted relative to the back plate, the flow channels being tilted such that upper portions thereof are tilted forward, with respect to a moving direction of the nozzle relative to the back plate, about lower ends of the flow channels, and delivering the rib material from the nozzle while moving the nozzle and the back plate relative to each other.

With the back plate for a flat panel display according to this invention, the rib material is delivered from a direction tilted, relative to the back plate, forward with respect to the direction of relative movement of the nozzle to apply a horizontal velocity component acting in the direction of relative movement of the back plate, to the rib material delivered to the back plate. The horizontal velocity component of the rib material is made equal to a relative moving velocity component of the back plate resulting from the relative movement between the nozzle and back plate. That is, a velocity difference is reduced. This delivery mode suppresses deformation of the rib material delivered, thereby depositing the rib material on the back plate in a desired shape determined by the discharge openings of the nozzle. This stabilizes the shape of the barrier ribs, and facilitates barrier rib forming controls to obtain the desired shape. The material may be used efficiently to form barrier ribs with high accuracy.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic view showing a nozzle in vertical posture delivering a rib material to a back plate;

FIG. 2 is a schematic view showing narrow barrier ribs formed on a back plate;

FIG. 3 is a schematic view showing barrier ribs formed on a back plate and having a reduced width except at tops thereof;

FIG. 4 is a schematic view showing barrier ribs formed on a back plate and having a reduced width except at bottoms thereof;

FIG. 5 is a side view schematically showing an outline of an apparatus for forming barrier ribs for use in flat panel displays in a first embodiment of this invention;

FIG. 6A is a front view of a nozzle in the first embodiment;

FIG. 6B is a sectional view taken on line 101-101 of FIG. 6A;

FIG. 7 is a schematic sectional view of the nozzle delivering a rib material in the first embodiment;

FIG. 8 is a schematic perspective view of a delivery unit delivering the rib material in the first embodiment;

FIG. 9 is a view showing a preferred arrangement of a plurality of nozzles;

FIG. 10 is an explanatory view illustrating discharge openings of the nozzles;

FIG. 11 is an explanatory view illustrating hourglass-shaped discharge openings of a nozzle in front view;

FIG. 12 is an explanatory view illustrating the hourglass-shaped discharge openings of the nozzle;

FIG. 13 is a side view of barrier ribs formed by the nozzle of FIG. 11;

FIG. 14 is an explanatory view of a nozzle different from the nozzle shown in FIG. 12;

FIG. 15 is a side view of barrier ribs formed by the nozzle of FIG. 14;

FIGS. 16A-C are schematic views illustrating nozzles with planar discharge openings;

FIG. 17 is a side view schematically showing an outline of an apparatus for forming barrier ribs for use in flat panel displays in a second embodiment; and

FIG. 18 is a view in vertical section schematically showing a nozzle and adjacent components shown in FIG. 17.

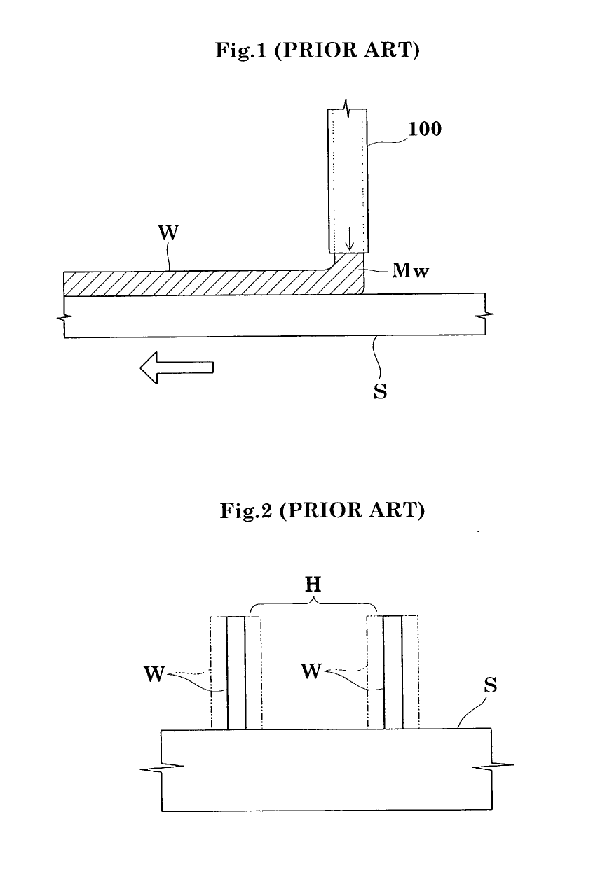

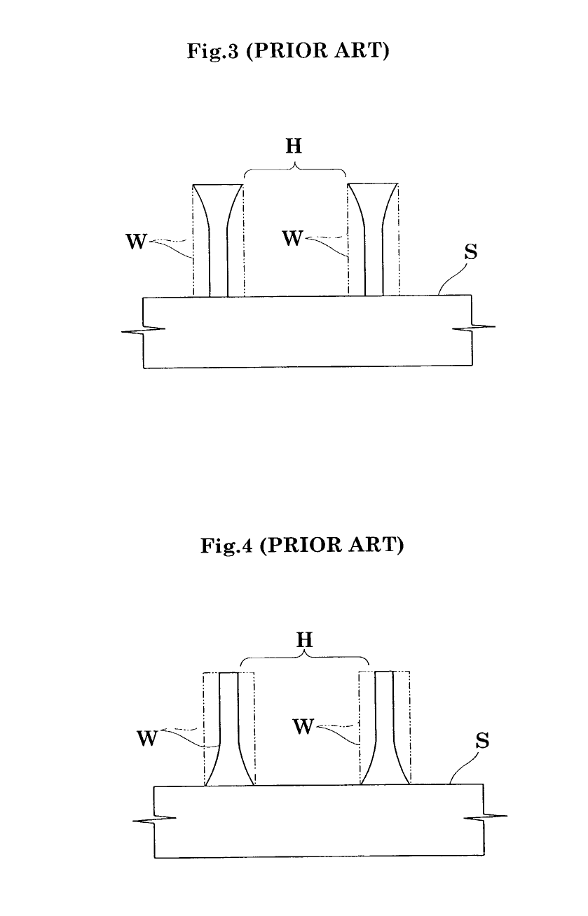

### DESCRIPTION OF THE PREFERRED EMBODIMENTS

Preferred embodiments of this invention will be described in detail hereinafter with reference to the drawings.

<First Embodiment>

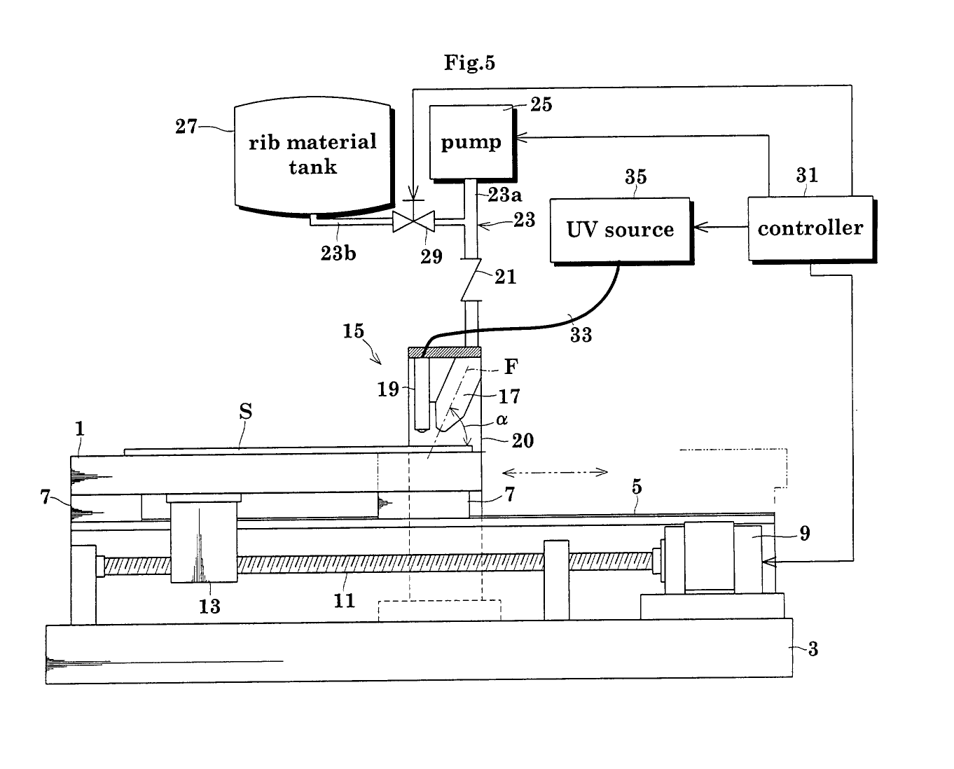

FIG. 5 is a side view schematically showing an outline of an apparatus for forming barrier ribs for use in flat panel displays according to this invention.

As shown in FIG. 5, a back plate S for a flat panel display is, for example, a glass substrate which is placed on a support table 1. A guide rail 5 is disposed on a base 3, and slide members 7 attached to a lower surface of the support table 1 are slidably fitted on the guide rail 5. With these components, the support table 1 is movable right and left in FIG. 5.

A motor 9 is mounted on an upper surface of the base 3, with a rotary shaft extending horizontally. A screw shaft 11 is connected to the rotary shaft of motor 9, and a connecting piece 13 attached to the lower surface of support table 1 is meshed with the screw shaft 11. Thus, by operating the motor 9, the support table 1 is moved right and left. The motor 9 corresponds to the moving device of this invention.

A delivery unit 15 for delivering a rib forming material is disposed adjacent a right-hand end of the support table 1 and adjacent the center of the base 3. The delivery unit 15 includes a nozzle 17 and a light emitter 19, and is attached to a frame 20 to straddle the support table 1. In the first embodiment, the rib material is delivered from the nozzle 17 when the support table 1 moves leftward relative thereto. The light emitter 19 is disposed to the left of the nozzle 17, corresponding to the rear of the nozzle 17 with respect to the movement of support table 1, in order to irradiate the rib material delivered to promote curing thereof.

The above light emitter 19 corresponds to the curing device of this invention.

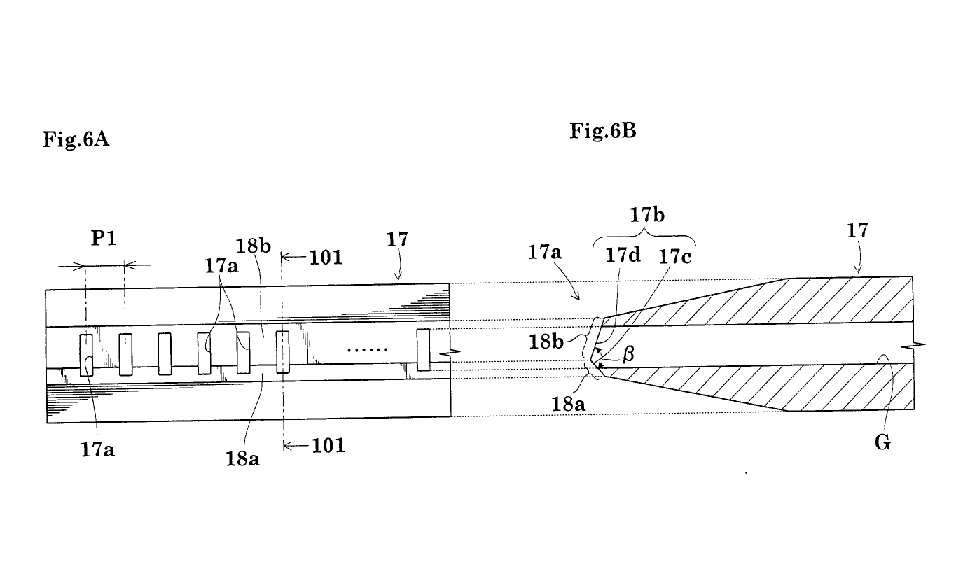

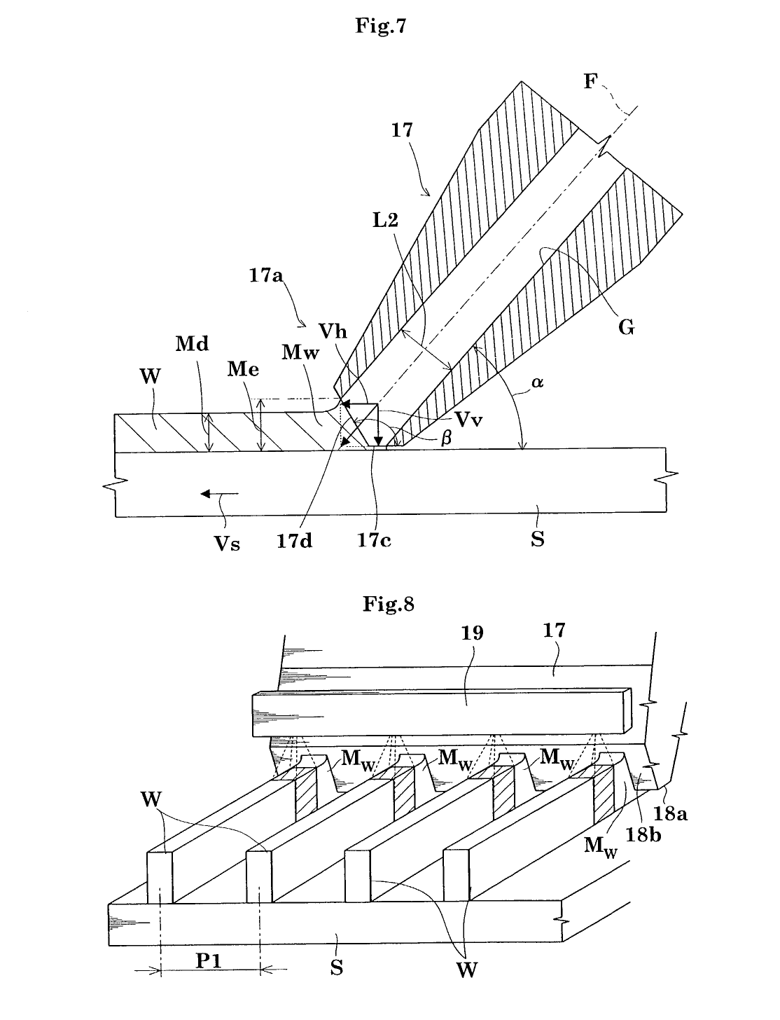

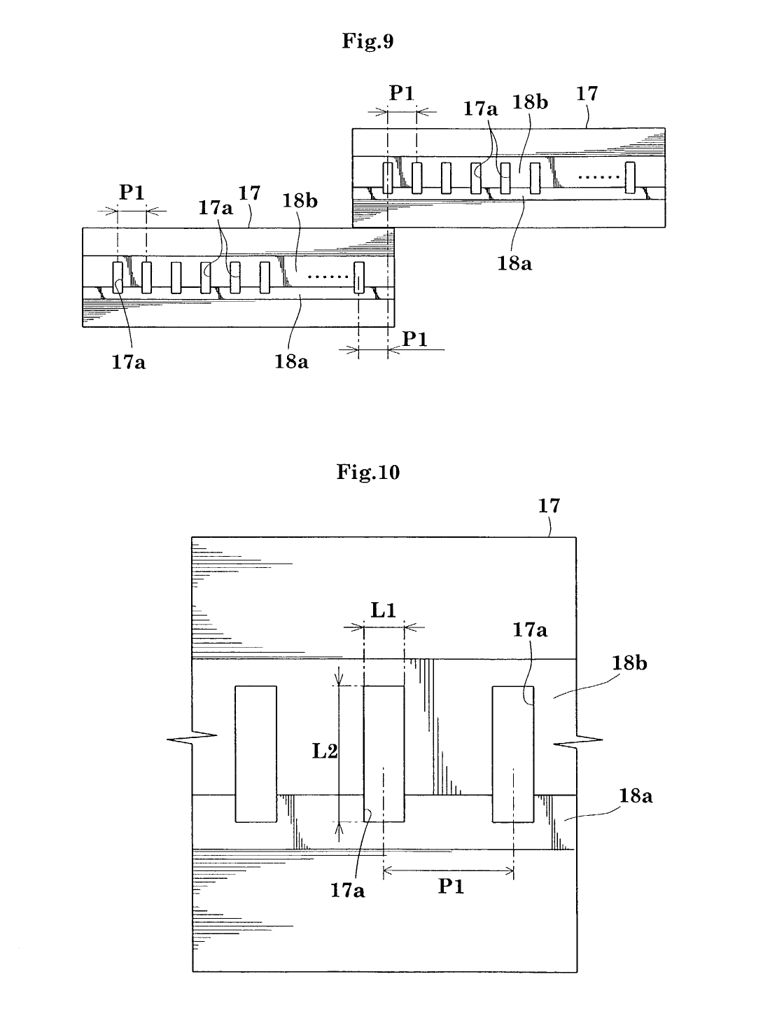

The nozzle 17 will be described with reference not only to FIG. 5 but also to FIGS. 6 through 10. FIG. 6A is a front view of the nozzle 17 in the first embodiment. FIG. 6B is a sectional view taken on line 101-101 of FIG. 6A. FIG. 7 is a schematic sectional view of the nozzle 17 delivering the rib material in the first embodiment. FIG. 8 is a schematic perspective view of the delivery unit 15 delivering the rib material in the first embodiment. FIG. 9 is a view showing a preferred arrangement of a plurality of nozzles 17. FIG. 10 is an explanatory view illustrating discharge openings 17a of the nozzles 17.

As shown in FIG. 5, the nozzle 17 is supported by the delivery unit 15 as tilted relative to the back plate S for delivering the rib material to the back plate S from a tilted direction F shown in a dot-and-chain line. With the nozzle 17 tilted in the direction F, as shown in FIG. 7, flow channels formed in the nozzle 17 for passage of the rib material are also tilted. The flow channels G are tilted such that an upper portion of the nozzle 17 is tilted forward, with respect to the moving direction of the nozzle 17 relative to the back plate S, about the lower end or discharge openings 17a of the nozzle 17. That is, in the first embodiment, while moving the support table 1 leftward, the rib material is delivered from the nozzle 17 stationary relative to the support table 1 and, as shown in FIG. 5, the upper portion of the nozzle 17 is tilted rightward about the discharge openings 17a of the nozzle 17. The above moving direction of the nozzle 17 relative to the back plate S refers to the rightward direction in the first embodiment. In other words, this is the direction opposite to the moving direction (leftward in FIG. 5) of the back plate S relative to the nozzle 17.

As shown in FIGS. 5 and 7, the nozzle 17 may have a tilt angle α, 0°<α<90°, relative to the back plate S, which preferably is in a range of 45 to 60 degrees. In the first embodiment, the tilt angle α of the nozzle 17 relative to the back plate S is set to about 60 degrees.

Reference is now made to FIG. 6A showing a front view of the nozzle 17. This nozzle 17 defines a plurality of discharge openings 17a arranged in a row in a direction normal to the plane of FIG. 5 and sideways in FIG. 6A. Each discharge opening 17a in the first embodiment is shaped rectangular and elongated vertically in front view.

As shown in FIG. 6B, the tip end of the nozzle 17 has a bifacial structure including a plane 18a substantially parallel to the back plate S and a plane 18b inclined relative to the back plate S in time of delivery of the rib material to the back plate S. The nozzle 17, with the tip end of bifacial structure, has opening planes 17b defining the discharge openings 17a and protruding in the direction of delivery of the rib material. As shown in FIGS. 6B and 7, each discharge opening 17a of the nozzle 17 includes a parallel opening plane 17c formed forwardly with respect to the moving direction of the nozzle 17 relative to the back plate S and substantially parallel to the back plate S, and an inclined opening plane 17d continuous with the parallel opening plane 17c and formed rearwardly with respect to the moving direction of the nozzle 17 relative to the back plate S and inclined relative to the back plate S. The parallel opening plane 17c and inclined opening plane 17d form an angle β therebetween which is at least 90 degrees and less than 180 degrees (e.g. about 120 degrees in the first embodiment). Thus, the plane 18a and inclined plane 18b form the same angle β of 120 degrees therebetween. Part of each discharge opening 17a of the nozzle 17 is formed in the plane 18a to define the parallel opening plane 17c. The remaining portion of each discharge opening 17a is formed in the inclined plane 18b to define the inclined opening plane 17d.

As shown in FIGS. 7 and 8, the nozzle 17 tilted relative to the back plate S has the parallel opening plane 17c of each discharge opening 17a parallel to and contacting or disposed adjacent (with a spacing of several tens of μm) the back plate S. The inclined opening plane 17d of each discharge opening 17a is inclined relative to the back plate S by a predetermined angle within a range exceeding 60 degrees and less than 90 degrees. Therefore, a portion belonging to the inclined opening plane 17d of the long side L2 (FIG. 10) of each discharge opening 17a of the nozzle 17 is inclined relative to the back plate S as is the inclined opening plane 17d. As shown in FIGS. 7 and 8, a projection to the support table 1 of the long side L2 of each discharge opening 17a corresponds to the moving direction of the support table 1. As shown in FIG. 10, the short side L1 of each discharge opening 17a is about 30 μm long, for example, while the long side L2 of each discharge opening 17a is about 500 μm long, for example. The discharge openings 17a are arranged at a pitch P1 of about 300 μm. As shown in FIG. 7, the height Me of the rib material at the instant of delivery is about 250 μm, for example, and the height Md of barrier ribs W is about 200 μm, for example. The discharge openings 17a may be given any shape and dimensions according to a desired shape in vertical section of the barrier ribs.

Reverting to FIG. 5, the nozzle 17 is connected to a supply pipe 23 with a check valve 21 mounted thereon. The supply pipe 23 has an upper pipe 23a connected to a pump 25, and a branch pipe 23b extending from the upper pipe 23a upstream of the check valve 21 to a rib material tank 27. The branch pipe 23b has a switch valve 29 mounted thereon.

The above motor 9, pump 25 and switch valve 29 are controlled by a controller 31 including a CPU not shown. The controller 31 operates the motor 9 to move the support table 1 leftward in FIG. 5, thereby moving the back plate S leftward relative to the nozzle 17. At this time, the controller 31 controls the pump 25 and switch valve 29 to deliver the rib material from the nozzle 17.

Specifically, the pump 25 is first operated to take sucking action, with the switch valve 29 opened, to draw the rib material into the upper pipe 23a. At this time, the check valve 21 prevents a rib material remaining in the nozzle 17 from being drawn back. Next, the pump 25 is operated to take discharging action, with the switch valve 29 closed, to discharge the rib material from the upper pipe 23a out through the check valve 21, thereby supplying the rib material to the nozzle 17. By repeating a series of these operations, the rib material is delivered from the discharge openings 17a of the nozzle 17.

A mechanism of delivering the rib material from the nozzle 17 to the back plate S will be described now. The delivery of the rib material from the nozzle 17 to the back plate S has the first to third basic factors as described hereunder. The lower ends of the rib material extruded (i.e. the width of the lower ends of barrier ribs) have a value close to the openings of nozzle 17. However, depending on the property of the rib material, wettability of the rib material at the tip of nozzle 17 and the rate of extrusion, the value may be slightly larger (when the nozzle 17 tends to be wet) or smaller (when the nozzle 17 tends to be dry to cause contracted veins) than the nozzle openings (i.e. the first factor). In a comparison between relative velocity of the nozzle 17 and back plate S and extruding rate of the rib material, the flows will widen in a situation like a pressing texture, and narrow in a situation like a pulling texture (i.e. the second factor). Further, the flows are influenced also by wettability with the back plate S. Since wettability is relatively good, the flows tend somewhat to spread after contacting the back plate S until curing (i.e. the third factor).

In the first embodiment, as shown in FIG. 7, the rib material is delivered to the back plate S from the direction F tilted forward with respect to the moving direction of the nozzle 17 relative to the back plate S. This delivery mode applies to the rib material delivered to the back plate S, a horizontal velocity component Vh in the direction of movement relative to the back plate S, and a vertical velocity component Vv in the direction perpendicular to the back plate S. The parallel opening plane of each discharge opening 17a of the nozzle 17 is placed in contact with or adjacent (with a spacing of several tens of μm) the back plate S, so that forward or lower ends of the rib material extruded may promptly reach the back plate S. The lower ends of the rib material extruded are suitably pressed against the back plate S, with a value (i.e. the width of the lower ends of barrier ribs) close to the openings (i.e. the short side L1) of nozzle 17. It will be appreciated that the vertical and horizontal velocity components Vv and Vh of the rib material delivered to the back plate S are variable with the rate of extruding the rib material from the nozzle 17. Thus, the force for pressing the rib material against the back plate S may be adjusted by varying the rate of extruding the rib material from the nozzle 17 to vary the vertical velocity component Vv.

By adjusting the rate of extruding the rib material from the nozzle 17, the horizontal velocity component Vh of the rib material may be made equal to a relative moving velocity component Vs of the back plate S resulting from the relative movement between the nozzle 17 and back plate S. This is achieved through a reduction in velocity difference between the horizontal velocity component Vh of the rib material and relative moving velocity component Vs of the back plate S. This suppresses deformation of the rib material delivered, thereby depositing the rib material on the back plate S in a desired shape determined by the discharge openings of the nozzle 17. That is, the barrier ribs W are formed with a bottom width of the nozzle openings (e.g. 30 μm)+several μm, and with a width approximately corresponding that of the nozzle openings (approx. 30 μm).

The light emitter 19 receives ultraviolet light from an ultraviolet source 35 connected thereto through an optical fiber 33 to promote curing of the rib material. While ultraviolet light is used in this embodiment, the type of light is not limited to ultraviolet light as long as the light can promote curing of the rib material. The rib material has a somewhat low viscosity to facilitate delivery from the nozzle 17, and has a UV curable resin mixed with a binder.

Apart from the use of ultraviolet light, the curing device may be adapted to cure the rib material by applying heat thereto (e.g. emitting heat or supplying a hot blast).

A rib forming operation by the above apparatus will be described next with reference to FIG. 8.

First, a back plate S is placed on the support table 1, and fixed thereto by suction, for example.

The nozzle 17 is tilted forward with respect to the moving direction of the nozzle 17 relative to the back plate S. When the motor 9 is rotated at fixed speed, the support table 1 is moved at fixed speed leftward relative to the stationary nozzle 17. This provides a relative moving step for moving the back plate S and tilted nozzle 17 relative to each other.

Next, while rotating the motor 9 at fixed speed, the pump 25 and switch valve 29 are controlled to deliver the rib material from the nozzle 17 as noted hereinbefore. Then, since the support table 1 moves at fixed speed leftward, the rib material M_{W} delivered in a plurality of flows from the nozzle 17 deposits to form linear walls on the upper surface of back plate S. In this way, a rib material delivery step is provided to deliver the rib material M_{W} from the nozzle 17 while moving the nozzle 17 and back plate S relative to each other. In the rib material delivery step, since the rib material is delivered in the direction F tilted relative to the back plate S, the vertical and horizontal velocity components Vv and Vh are applied to the rib material delivered to the back plate S. The velocity difference between the horizontal velocity component Vh of the rib material and the relative moving velocity component Vs of the back plate S is reduced by adjusting the rate of extruding the rib material from the nozzle 17 to equalize the horizontal velocity component Vh of the rib material and the relative moving velocity component Vs of the back plate S resulting from the relative movement between the nozzle 17 and back plate S.

In addition, as shown in dotted lines in FIG. 8, ultraviolet light is emitted from the light emitter 19 immediately after the delivery from the nozzle 17 to promote curing. Consequently, barrier ribs W are formed at the pitch P1 of arrangement of discharge openings 17a with hardly any sagging of the rib material M_{W}. In this way, a rib material curing step is provided to cure the rib material M_{W} on the back plate S while delivering the rib material M_{W} from the nozzle 17.

The time taken from immediately after the delivery of the rib material M_{W} to the curing thereof by the light emitter 19 is at most one second in the first embodiment, though it is variable with the scan speed of the nozzle 17 and the curing device such as the light emitter 19.

Finally, the product is baked at a temperature of 500 to 600° C. to complete barrier ribs for a flat panel display.

According to the apparatus for forming barrier ribs for use in flat panel displays in the first embodiment as described above, the rib material M_{W} is delivered to the back plate S from the direction F tilted forward with respect to the moving direction of the nozzle 17 relative to the back plate S. This applies a horizontal velocity component Vh in the direction of movement relative to the back plate S, to the rib material M_{W} delivered to the back plate S. The horizontal velocity component Vh of the rib material M_{W} is made equal to the relative moving velocity component Vs of the back plate S resulting from the relative movement between the nozzle 17 and back plate S, that is the velocity difference therebetween is reduced, to suppress deformation of the rib material M_{W} delivered. The rib material M_{W} is thereby deposited on the back plate S in a desired shape determined by the discharge openings 17a of the nozzle 17, to stabilize the shape of barrier ribs W. This facilitates barrier rib forming controls to obtain the desired shape.

The rib material M_{W}, while being delivered, is irradiated with ultraviolet light to be cured. That is, immediately after the delivery, the rib material M_{W} is irradiated with ultraviolet light to promote its curing. The rib material M_{W} is thereby maintained in shape on the back plate S. This simplifies the process to form barrier ribs W with high quality and high accuracy. Moreover, the rib material M_{W} is used efficiently to achieve low cost. Since the rib material M_{W} is cured immediately after delivery, the barrier ribs W may be formed to have a high aspect ratio.

Since the discharge openings 17a of the nozzle 17 are vertically elongated in front view, the barrier ribs W of vertically elongated section may be formed on the back plate S. The nozzle 17 is disposed such that the discharge openings 17a are directed reverse to the moving direction, with the long side L2 of each discharge opening 17a inclined relative to the back plate S. Consequently, the rib material delivered from the lower portions of discharge openings 17a contacts the back plate S relatively hard, to attain strong adhesion of the rib material to the back plate S. The rib material is delivered with less force from the upper portions of discharge openings 17a, to realize a high aspect ratio without deforming the barrier ribs W. Thus, barrier ribs W of high aspect ratio may be formed on the back plate S.

The nozzle 17 has opening planes 17b defining the discharge openings 17a and protruding in the direction of delivery of the rib material. This configuration facilitates the rib material being delivered to the back plate S as retaining the shape given by the inner walls of the nozzle 17, thereby further stabilizing the shape of the barrier ribs formed on the back plate S.

Each discharge opening 17a of the nozzle 17 includes a parallel opening plane 17c formed forwardly with respect to the moving direction of the nozzle 17 relative to the back plate S and substantially parallel to the back plate S, and an inclined opening plane 17d continuous with the parallel opening plane 17c and formed rearwardly with respect to the moving direction of the nozzle 17 relative to the back plate S and inclined relative to the back plate S. The parallel opening plane 17c and inclined opening plane 17d form an angle beta therebetween which is at least 90 degrees and less than 180 degrees. Thus, while securing barrier rib formation with a high aspect ratio, the discharge openings 17a of the nozzle 17 are placed in contact with or adjacent the back plate S. The rib material may be delivered to the back plate S, with facility, as retaining the shape given by the inner walls of the nozzle 17, thereby further stabilizing the shape of the barrier ribs formed on the back plate S.

Where the back plate S has such a large area that barrier ribs W cannot be formed over a desired area at a time, the support table 1 may be returned to an initial position to carry out the above process again after shifting the nozzle 17, with a shift mechanism not shown, in a direction normal to the plane of FIG. 5.

A plurality of nozzles 17 may be arranged in a row. If, however, the plurality of nozzles 17 were simply aligned, the pitch P1 of arrangement of discharge openings 17a that determines the pitch of barrier ribs W would be increased by the thickness of end walls of the nozzles 17, to disrupt the pitch of barrier ribs W. It is thus preferable that, as shown in FIG. 9, the nozzles 17 are arranged with adjacent ends thereof partly overlapping each other so that the discharge openings 17a of adjacent nozzles 17 are arranged at the pitch P1. With the plurality of nozzles 17 arranged in this way, barrier ribs may be formed over a large area at a time to reduce the number of forming steps.

Part of the discharge openings 17a of the nozzle 17, and more particularly the parallel opening planes 17c of the discharge openings 17a, are placed in contact with the back plate S. Even where the back plate S has “waves”, the rib material is delivered to the back plate S, following the waves of the back plate S. Thus, no variations occur with the height of barrier ribs W, thereby stabilizing the height of barrier rib W. Since the back plate S is harder than the nozzle 17, no damage will be done to the back plate S. Where the discharge openings 17a of the nozzle 17 are placed out of contact with the back plate S and the back plate S has “waves”, the spacing between support table 1 and nozzle 17 may be maintained constant by using a distance measuring device for measuring a distance between the upper surface of back plate S and the nozzle 17, and a lift device for varying a vertical relationship between the nozzle 17 and support table 1. This measure will stabilize the height of barrier ribs W.

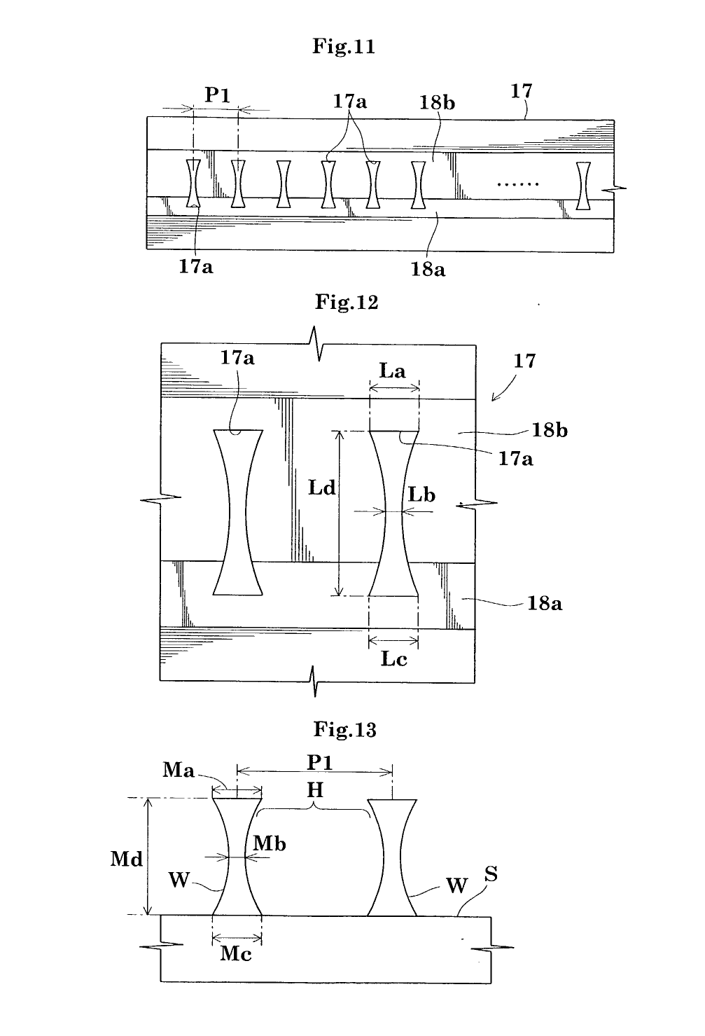

The discharge openings 17a of the nozzle 17 are not limited to the elongated rectangular shape noted hereinbefore, but may be oval or other oblong shapes. The discharge openings 17a of the nozzle 17 shaped like an hourglass as shown in FIGS. 11 and 12 will be described hereinafter. These discharge openings 17a are vertically elongated in front view, each constricted at the middle Lb and enlarged at opposite ends (i.e. at the top La and bottom Lc). The discharge openings 17a of the nozzle 17 shown in FIG. 12 have the following preferred dimensions at the top La, middle Lb and bottom Lc.

A preferred relationship is such that width at the top La or bottom Lc: width at the middle Lb=larger than 1 but not exceeding 3:1. For example, the width at the top La and bottom is 100 μm, and the width at the middle Lb 30 μm. It is more preferable that width at the top La or bottom Lc: width at the middle Lb=1.5 to 3:1. It is still more preferable that width at the top La or bottom Lc: width at the middle Lb=2:1. In this case, the width at the middle Lb is 50 μm.

Here, the width at the top La and bottom Lc of each discharge opening 17a is about 100 μm, and the width at the middle Lb about 50 μm. The length Ld in the longitudinal direction of each discharge opening 17a is 500 μm. The discharge openings 17a are arranged at a pitch P1 of about 300 μm. Where the discharge openings 17a of the nozzle 17 tilted relative to the back plate S have the above hourglass-like profile, barrier ribs W of hourglass-like profile as shown in FIG. 13 are steadily formed on the back plate S. The barrier ribs W formed on the back plate S have a width of about 100 μm at the top Ma and bottom Mc and a width of about 50 μm at the middle Mb. The height Md of barrier ribs W is about 200 μm. The barrier ribs W are arranged at a pitch P1 of about 300 μm.

The barrier ribs W formed on the back plate S to have an hourglass-like vertical section have the following advantages. The barrier ribs W with the width not reduced at the bottom Mc have good adhesion to the back plate S. The barrier ribs W with the width not reduced at the top Ma and forming black stripes provide image quality with “life”. Further, the barrier ribs W constricted at the middle Mb provide large emission spaces H therebetween to secure a high brightness level. These advantages make an all-around flat panel display.

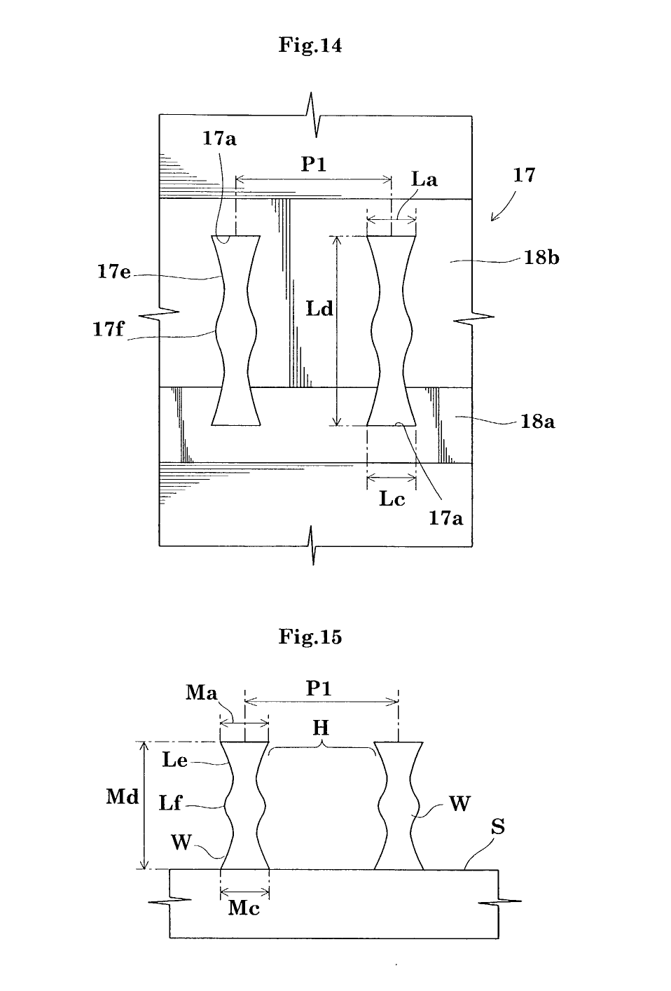

As shown in FIG. 14, the discharge openings 17a of the nozzle 17 may have curved edges 17e defining bulges 17f. By employing the nozzle 17 shown in FIG. 14, barrier ribs W having curved sides Le with bulges Lf may be formed as shown in FIG. 15. The bulges Lf on the curved sides Le of barrier ribs W increase the surface areas on the sides of barrier ribs W to provide a flat panel display with further improved brightness.

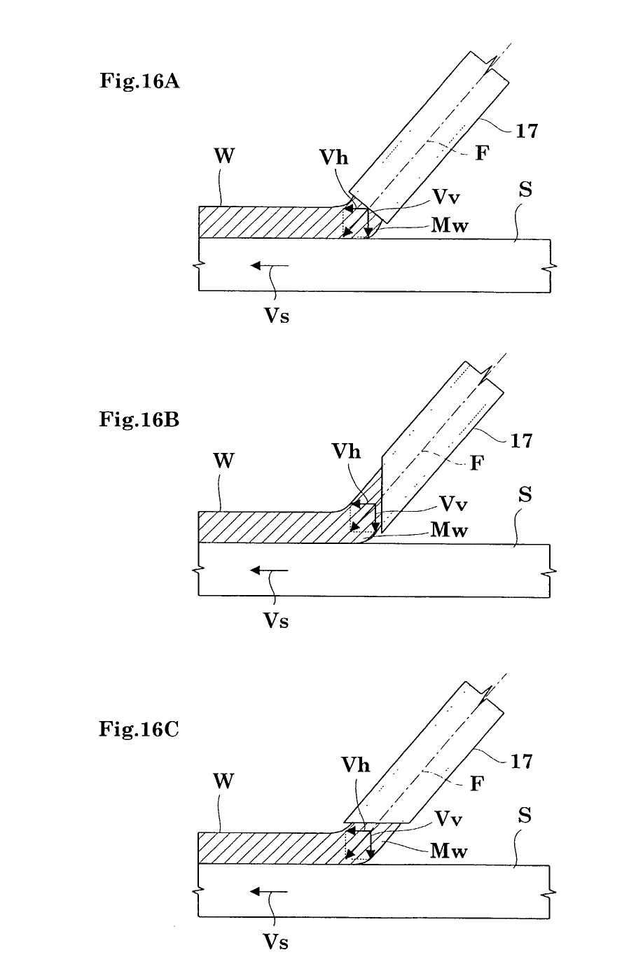

The first embodiment described above, as shown in FIGS. 6 and 7, employs the nozzle 17 having discharge openings 17a of bifacial structure. Instead, a nozzle 17 having discharge openings 17a of one-face structure may be employed. As shown in FIGS. 16A-C, a tilted nozzle may have discharge openings 17a of one-face structure tilted relative to the back plate S, or perpendicular to or parallel to the back plate S.

The nozzle 17 shown in FIG. 16A, for example, is tilted in the direction F relative to the back plate S, with discharge openings 17a arranged in a plane perpendicular to the direction F in which the nozzle 17 is tilted. The nozzle 17 shown in FIG. 16B is tilted in the direction F relative to the back plate S, with discharge openings 17a arranged in a plane perpendicular to the back plate S. The nozzle 17 shown in FIG. 16C is tilted in the direction F relative to the back plate S, with discharge openings 17a arranged in a plane parallel to the back plate S.

Each of the nozzles 17 shown in FIGS. 16A-C, with the tilted posture, can apply a vertical velocity component Vv and a horizontal velocity component Vh to the rib material M_{W} delivered to the back plate S as in the first embodiment. The vertical velocity component Vv presses the rib material M_{W} against the back plate S. The horizontal velocity component Vh of the rib material M_{W} may be made equal to the relative moving velocity component Vs of the back plate S resulting from the relative movement between the nozzle 17 and back plate S, to eliminate a velocity difference therebetween, thereby suppressing deformation of the rib material M_{W} delivered to the back plate S. The rib material M_{W} is thereby deposited on the back plate S in a desired shape determined by the discharge openings 17a of the nozzle 17, to stabilize the shape of barrier ribs W. However, with each of the nozzles 17 shown in FIGS. 16A-C, the rib material departs from the discharge openings 17a earlier than with the nozzle 17 of bifacial structure shown in FIGS. 6 and 7. The earlier departure results in formation on the back plate S of barrier ribs somewhat lacking in profile stability, compared with use of the nozzle 17 of bifacial structure shown in FIGS. 6 and 7. The nozzle 17 shown in FIG. 16C, in particular, must have its tip end spaced from the back plate S.

<Second Embodiment>

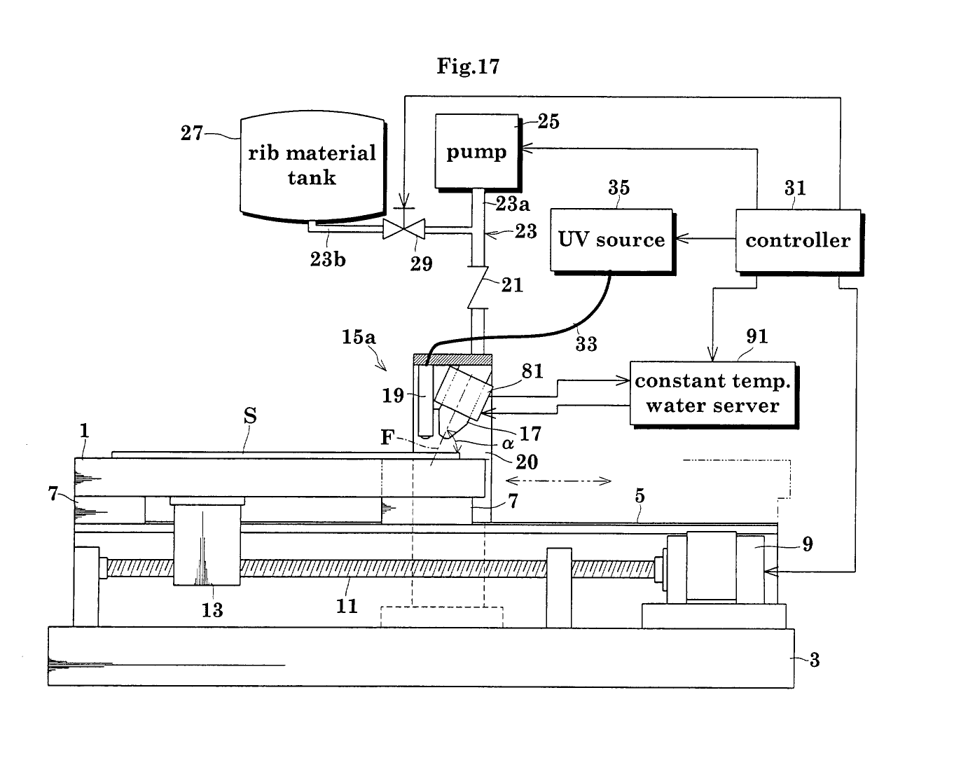

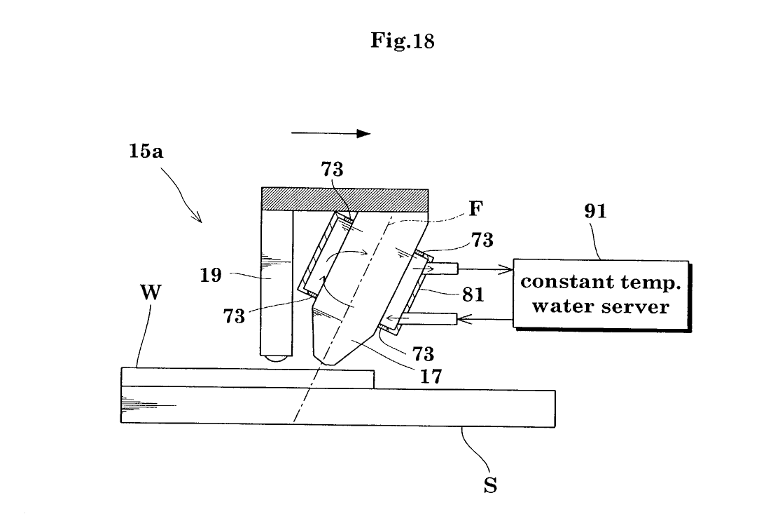

A second embodiment will be described with reference to FIGS. 17 and 18. FIG. 17 is a side view schematically showing an outline of an apparatus for forming barrier ribs for use in flat panel displays in the second embodiment. FIG. 18 is a view in vertical section schematically showing a nozzle and adjacent components shown in FIG. 17.

In the first embodiment described hereinbefore, barrier ribs W are formed directly by delivering the rib material to the back plate S without adjusting the temperature of nozzle 17. In the second embodiment, barrier ribs W are formed by delivering from the nozzle 17 the rib material maintained at a constant temperature. That is, the rib material delivery step in the foregoing first embodiment, here, includes a rib material constant temperature delivery step for delivering the rib material from the nozzle 17 while moving the nozzle 17 and back plate S relative to each other, and while maintaining the rib material at a constant temperature. Like references are used to identify like parts which are the same as in the first embodiment and will not be described again.

The second embodiment provides a delivery unit 15a. The delivery unit 15a includes a nozzle 17 and a light emitter 19 as in the foregoing first embodiment, and further includes a cooling jacket 81 surrounding the nozzle 17. The cooling jacket 81 is connected to a constant temperature water server 91 for supplying the cooling jacket 81 with constant temperature water.

The constant temperature water server 91 is capable of supplying the cooling jacket 81 with constant temperature water maintained at a desired temperature within a predetermined temperature range (e.g. 0° C. to room temperature: 23° C.). It is assumed that, in the second embodiment, the cooling jacket 81 is supplied with constant temperature water at a lower temperature (e.g. 15° C.) than the temperature of a room where the subject apparatus is installed (e.g. 23° C.). Further, the second embodiment will be described, assuming that the rib material includes an acrylic oligomer or an acrylic monomer with a viscosity in the order of 100,000 mPa/s (milli-Pascal per second) and ceramics powder (glass powder).

As shown in FIG. 18, the cooling jacket 81 is a hollow container mounted to cover the outer circumference of nozzle 17. Constant temperature water is supplied from the constant temperature water server 91 to the hollow portion of the cooling jacket 81. The constant temperature water supplied contacts the outer circumference of the nozzle 17 to maintain the nozzle 17 itself at the constant temperature, thereby to maintain the rib material in the nozzle 17 at the constant temperature. The constant temperature water outputted from the constant temperature water server 91 is inputted to an input port of the cooling jacket 81. The constant temperature water in the cooling jacket 81 is drained from an output port of the cooling jacket 81. The interior of the cooling jacket 81 is filled with the constant temperature water in a predetermined quantity circulating therethrough. Piping for connecting the cooling jacket 81 and constant temperature water server 91 has a double pipe construction with temperature retaining property to avoid temperature change of the constant temperature water being supplied from the constant temperature water server 91 to the cooling jacket 81.

Seals 73 are disposed between the nozzle 17 and cooling jacket 81 to prevent the constant temperature water in the cooling jacket 81 from leaking out from between the nozzle 17 and cooling jacket 81. The nozzle 17 and cooling jacket 81 may be manufactured as an integral unit to dispense with the seals 73.

The cooling jacket 81 and constant temperature water server 91 correspond to the thermostat device of this invention.

A rib forming operation by the above apparatus will be described next with reference to FIG. 17.

First, a back plate S is placed on the support table 1, and fixed thereto by suction, for example.

The constant temperature water server 91 starts a circulating supply of constant temperature water at the predetermined temperature (e.g. 15° C.) to the cooling jacket 81. The temperature of the room where the apparatus in this embodiment is installed is set to 23° C., for example. The outer circumference of the nozzle 17 becomes a fixed temperature (e.g. 15° C.) through contact with the constant temperature water in the cooling jacket 81. The rib material in the nozzle 17 also is maintained at the fixed temperature (e.g. 15° C.). Since the room temperature is 23° C., the viscosity of the rib material moving from the rib material tank 27 to the nozzle 17 is approximately 100,000 mPa/s (milli-Pascal per second). The viscosity of the rib material in the nozzle 17, which is maintained at the fixed temperature (e.g. 15° C.), increases to a high level, i.e. 100,000+8,000 (8° C.=164,000 mPa/s (milli-Pascal per second).

Next, while rotating the motor 9 at fixed speed, the pump 25 and switch valve 29 are controlled, as in the first embodiment, to deliver the rib material at the constant temperature from the nozzle 17. A small quantity of rib material consumed in forming minute barrier ribs is easily cooled in the thin nozzle 17 in a short time, and delivered while being maintained at the fixed temperature (e.g. 15° C.). Then, since the support table 1 moves at fixed speed leftward, the rib material M_{W} delivered in a plurality of flows from the nozzle 17 deposits to form linear walls on the upper surface of back plate S. Moreover, the rib material is delivered as maintained at the fixed temperature (e.g. 15° C.), i.e. as maintained at a fixed viscosity (e.g. 100,000+8,000×8° C.=164,000 mPa/s (milli-Pascal per second)). Thus, the rib material is delivered from the nozzle 17 in a fixed state to reduce variations in the rib profile and stabilize the rib profile. Further, ultraviolet light is emitted from the light emitter 19 immediately after the delivery from the nozzle 17 to promote curing. Consequently, barrier ribs W are formed at the pitch P1 of arrangement of discharge openings 17a with a still less chance of sagging of the rib material M_{W} than in the first embodiment. The time taken from immediately after the delivery of the rib material to the curing thereof by the light emitter 19 is at most one second in this second embodiment, though it is variable with the scan speed of the nozzle 17 and the curing device such as the light emitter 19. Finally, the product is baked at a temperature of 500 to 600° C. to complete barrier ribs for a flat panel display.

As noted above, the rib material is delivered from the nozzle 17 as maintained at the fixed temperature. Particularly, in forming barrier ribs required to have a high aspect ratio, the rib material not cured yet after the delivery is deformed to a fixed extent by surface tension and gravity within a time elapsed until curing of the rib material. The fixed state of rib material delivery from the nozzle 17 stabilizes the shape and size of the barrier ribs.

Since the rib material supplied is maintained at the constant temperature in the nozzle 17, the rib material is delivered from the nozzle 17 in the fixed state to achieve stability of the shape and size of the barrier ribs efficiently by a small amount energy. In the second embodiment, the rib material supplied is maintained at the constant temperature in the nozzle 17. The same effect will be produced by maintaining the rib material at the constant temperature in the vicinity of the nozzle 17, instead.

The rib material supplied is delivered as maintained at the constant temperature in or adjacent the nozzle 17, which is lower than the temperature upstream of the nozzle 17. Thus, the rib material may be transported in a low viscosity condition to the nozzle 17 or to the vicinity of the nozzle 17. The viscosity of the rib material may be increased only in or adjacent the nozzle 17. This facilitates transportation of the rib material. There is no need to provide a pressure resistant design for the rib material supply system, or to use a pump of increased pressure.

The viscosity of the rib material may be increased in time of delivery by lowering the temperature of the rib material in or adjacent the nozzle 17 below room temperature. This achieves a high aspect ratio required of the barrier ribs with ease. Since the rib material in or adjacent the nozzle 17 is maintained at the low temperature, the increase in the viscosity of the rib material in the nozzle 17 does not cause a great increase in resistance to the delivery. Rib materials of lower viscosity may be included in a range for selection. A rib material which becomes highly viscous (e.g. several hundred thousand mPa/s) near room temperature is difficult to manufacture by increasing the degree of polymerization of a resin used in the rib material. According to this invention, however, a rib material having a high viscosity in the order of 1,000,000 mPa/s may be produced with ease.

This invention may be modified as follows:

<Modifications>

(1) In the above embodiments, the support table 1 with the back plate S placed thereon is constructed movable. Instead, the support table 1 may be fixed, with the delivery unit 15 or delivery unit 15a adapted movable.

(2) In the above embodiments, the entire nozzle 17 is tilted relative to the back plate S. Instead, only an exit portion adjacent the discharge openings 17a of the nozzle 17 may be tilted relative to the back plate S. Further, the nozzle may be maintained in vertical posture, with at least the flow channels of the rib material at the exit portion of the nozzle tilted inside the nozzle relative to the back plate S.

(3) In the above embodiments, the rib material, while being delivered, is cured by emitting ultraviolet light thereto. The rib material may be cured as appropriate by emitting different light or heat or supplying a hot blast.

(4) In the second embodiment described above, the water-cooling constant temperature water server 91 is employed as the thermostat device. This device may, for example, use an air-cooling system or Peltier effect.

The present invention may be embodied in other specific forms without departing from the spirit or essential attributes thereof and, accordingly, reference should be made to the appended claims, rather than to the foregoing specification, as indicating the scope of the invention.

What is claimed is:

1. A method of forming barrier ribs on a back plate for use in a flat panel display, said method comprising:
a relative moving step for moving rib material delivery nozzle means and said back plate relative to each other, with at least flow channels of a rib material in an exit portion of said nozzle means tilted relative to said back plate, said flow channels being tilted such that upper portions thereof are tilted forward, with respect to a moving direction of said nozzle means relative to said back plate, about lower ends of said flow channels; and
a rib material delivery step for delivering said rib material from said nozzle means while moving said nozzle means and said back plate relative to each other.

2. A method of forming barrier ribs for a flat panel display as defined in claim 1, further comprising a rib material curing step for curing said rib material on said back plate while delivering said rib material from said nozzle means.

3. An apparatus for forming barrier ribs on a back plate for use in a flat panel display, said apparatus comprising:
nozzle means for delivering a rib material;
a support table for supporting said back plate; and
moving means for moving said nozzle means and said support table relative to each other;
wherein said rib material is delivered from said nozzle means while said nozzle means and said back plate relative to each other, with at least flow channels of said rib material in an exit portion of said nozzle means tilted relative to said back plate, said flow channels being tilted such that upper portions thereof are tilted forward, with respect to a moving direction of said nozzle means relative to said back plate, about lower ends of said flow channels.

4. An apparatus for forming barrier ribs for a flat panel display as defined in claim 3, further comprising curing means for curing said rib material delivered to said back plate, said curing means curing said rib material on said back plate while said rib material is delivered from said nozzle means.

5. An apparatus for forming barrier ribs for a flat panel display as defined in claim 3, wherein said nozzle means has discharge openings vertically elongated in front view.

6. An apparatus for forming barrier ribs for a flat panel display as defined in claim 4, wherein said nozzle means has discharge openings vertically elongated in front view.

7. An apparatus for forming barrier ribs for a flat panel display as defined in claim 5, wherein said nozzle means is disposed such that said discharge openings have long sides thereof tilted relative to said back plate to be directed reverse to said moving direction.

8. An apparatus for forming barrier ribs for a flat panel display as defined in claim 6, wherein said nozzle means is disposed such that said discharge openings have long sides thereof tilted relative to said back plate to be directed reverse to said moving direction.

9. An apparatus for forming barrier ribs for a flat panel display as defined in claim 7, wherein each of said discharge openings is hourglass-shaped with an upper end and a lower end thereof enlarged in front view.

10. An apparatus for forming barrier ribs for a flat panel display as defined in claim 8, wherein each of said discharge openings is hourglass-shaped with an upper end and a lower end thereof enlarged in front view.

11. An apparatus for forming barrier ribs for a flat panel display as defined in claim 9, wherein each of said discharge openings has curved edges defining bulges.

12. An apparatus for forming barrier ribs for a flat panel display as defined in claim 10, wherein each of said discharge openings has curved edges defining bulges.

13. An apparatus for forming barrier ribs for a flat panel display as defined in claim 5, wherein said nozzle means has opening planes defining said discharge openings and protruding in a direction of delivery of said rib material.

14. An apparatus for forming barrier ribs for a flat panel display as defined in claim 6, wherein said nozzle means has opening planes defining said discharge openings and protruding in a direction of delivery of said rib material.

15. An apparatus for forming barrier ribs for a flat panel display as defined in claim 8, wherein said nozzle means has opening planes defining said discharge openings and protruding in a direction of delivery of said rib material.

16. An apparatus for forming barrier ribs for a flat panel display as defined in claim 13, wherein each of said discharge openings includes:
a parallel opening plane formed forwardly with respect to said moving direction of said nozzle relative to said back plate and substantially parallel to said back plate; and
an inclined opening plane continuous with said parallel opening plane and formed rearwardly with respect to said moving direction and inclined relative to said back plate;
said parallel opening plane and said inclined opening plane forming an angle beta therebetween which is at least 90 degrees and less than 180 degrees.

17. An apparatus for forming barrier ribs for a flat panel display as defined in claim 14, wherein each of said discharge openings includes:
a parallel opening plane formed forwardly with respect to said moving direction of said nozzle relative to said back plate and substantially parallel to said back plate; and
an inclined opening plane continuous with said parallel opening plane and formed rearwardly with respect to said moving direction and inclined relative to said back plate;
said parallel opening plane and said inclined opening plane forming an angle beta therebetween which is at least 90 degrees and less than 180 degrees.

18. A flat panel display comprising barrier ribs formed on a back plate, wherein said barrier ribs are formed on said back plate, each to have a hourglass-like shape with an upper end and a lower end thereof enlarged.

19. A flat panel display as defined in claim 18, wherein each of said barrier ribs has curved sides defining bulges.

20. A back plate for a flat panel display comprising barrier ribs formed thereon by moving rib material delivery nozzle means and said back plate relative to each other, with at least flow channels of a rib material in an exit portion of said nozzle means tilted relative to said back plate, said flow channels being tilted such that upper portions thereof are tilted forward, with respect to a moving direction of said nozzle means relative to said back plate, about lower ends of said flow channels, and delivering said rib material from said nozzle means while moving said nozzle means and said back plate relative to each other.
